(19) United States
(12) Patent Application Publication
(10) Pub. No.: US 2010/0223283 A1
(43) Pub. Date: Sep. 2, 2010

(54) APPARATUS AND METHOD FOR PROCESSING QUERY

(75) Inventors: Chung-ho Lee, Daejeon (KR); Min Soo Kim, Daejeon (KR); Yong Joon Lee, Daejeon (KR); Jong-Hyun Park, Daejeon (KR)

Correspondence Address: LADAS & PARRY LLP, 224 SOUTH MICHIGAN AVENUE, SUITE 1600, CHICAGO, IL, 60604, US

(73) Assignee: Electronics and Telecommunications Research Institute, Daejeon-city (KR)

(21) Appl. No.: 12/682,922

(22) PCT Filed: Jun. 25, 2008
(86) PCT No.: PCT/KR2008/003658

§ 371 Date: Apr. 14, 2010

(30) Foreign Application Priority Data
Nov. 9, 2007 (KR) 10-2007-0114239

(51) Int. Cl. G06F 17/30

(52) U.S. Cl. 707/769; 707/E17.014

(57) ABSTRACT

An apparatus for processing a query in a plurality of heterogeneous sensor networks includes a query queue, a query combining and converting unit, a query command manager, and a data combiner. The query queue receives a plurality of queries from a user interface and stores them and the query combining and converting unit combines or converts the queries according to the heterogeneous sensor networks. The query command manager transmits the combined or converted queries to a corresponding sensor network from among the heterogeneous sensor networks, and the data combiner transmits a result according to the data received from the heterogeneous sensor networks to a user interface.

### TECHNICAL FIELD

The present invention relates to an apparatus and a method for processing queries in heterogeneous sensor networks.

This work was supported by the IT R&D program of MIC/IITA [2006-S-022-02, Development of USN Middleware Platform Technology].

### BACKGROUND ART

A query processing method in the sensor network environment includes a sensor network query processor and a data stream management system (DSMS).

The sensor network query processor processes a query by optimizing a query that approaches sensor data, assuming a homogeneous sensor network regarding data dissemination approach and query processing capability. The data stream management system processes the query by performing a continuous query on the input stream data without considering the sensor network characteristic.

The query processing method has different targets for optimizing the query approaching the sensor data or optimizing continuous queries. Therefore, a method for efficiently processing multiple queries of heterogeneous sensor networks having different characteristics is required regarding the data dissemination approach and the query processing capability.

### DISCLOSURE OF INVENTION

### Technical Problem

The present invention has been made in an effort to provide a device and method for efficiently processing multiple queries performed for heterogeneous sensor networks having different characteristics.

### Technical Solution

An exemplary embodiment of the present invention provides an apparatus for processing a plurality of queries from a plurality of heterogeneous sensor networks including a query queue receiving a plurality of queries from a user interface and storing the queries, a query combining and converting unit combining or converting the queries according to the heterogeneous sensor networks, a query command manager transmitting the combined or converted query to a corresponding sensor network from among the heterogeneous sensor networks, and a data combiner transmitting a result based on data received from the heterogeneous sensor networks to the user interface.

Another embodiment of the present invention provides a method for processing a plurality of queries from a plurality of heterogeneous sensor networks including receiving and storing the queries that are performed at the same time for the heterogeneous sensor networks, combining or converting the queries by using information on the heterogeneous sensor networks, transmitting a combined or converted query to a corresponding sensor network from among the heterogeneous sensor networks, and receiving the data following the combined or converted query from the heterogeneous sensor networks.

### ADVANTAGEOUS EFFECTS

Therefore, in the exemplary embodiment of the present invention, a plurality of continuous queries that are performed at the same time for different sensor networks can be efficiently processed, and various types of queries are processed irrespective of the characteristic of the sensor network to minimize the query cost of the entire network and acquire a fast response speed.

### BRIEF DESCRIPTION OF THE DRAWINGS

An exemplary embodiment of the present invention will be described in detail with reference to the accompanying drawings for clear understanding of advantages of the present invention, wherein:

FIG. 1 shows a heterogeneous wireless network according to a data dissemination approach according to an exemplary embodiment of the present invention;

FIG. 2 and FIG. 3 are examples of queries according to a data dissemination approach on a heterogeneous wireless network shown in FIG. 1;

FIG. 4 shows a heterogeneous wireless network according to query processing capability according to an exemplary embodiment of the present invention;

FIG. 5 is a block diagram of a heterogeneous sensor network query processor according to an exemplary embodiment of the present invention;

FIG. 6 is an example for minimizing the number of pull approach queries according to an exemplary embodiment of the present invention;

FIG. 7 is an example of a query optimization policy using query processing capability of a sensor network according to an exemplary embodiment of the present invention; and

FIG. 8 is a flowchart of an efficiency query processing method performed by a heterogeneous sensor network query processor according to an exemplary embodiment of the present invention.

### MODE FOR THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Through the entire specification, unless explicitly described to the contrary, the word “comprise” and variations such as “comprises” or “comprising” will be understood to imply the inclusion of stated elements but not the exclusion of any other elements.

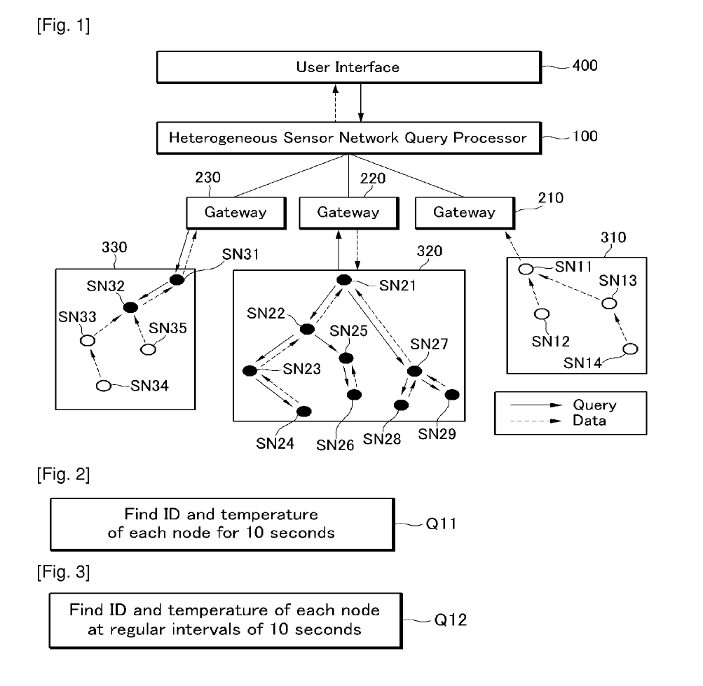

Referring to FIG. 1 to FIG. 4, an apparatus and a method for processing queries in heterogeneous sensor networks according to an exemplary embodiment of the present invention will now be described.

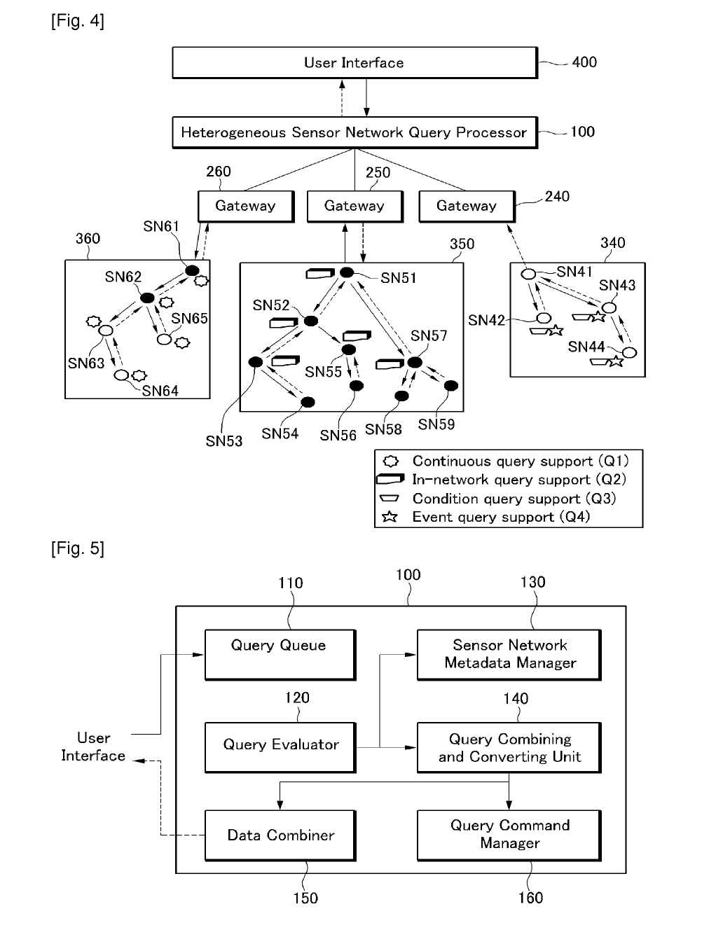

FIG. 1 shows a heterogeneous wireless network according to a data dissemination approach according to an exemplary embodiment of the present invention, and FIG. 2 and FIG. 3 are examples of queries according to a data dissemination approach on a heterogeneous wireless network shown in FIG. 1. FIG. 4 shows a heterogeneous wireless network according to query processing capability according to an exemplary embodiment of the present invention.

As shown in FIG. 1, the heterogeneous wireless network includes a heterogeneous sensor network query processor 100, a plurality of gateways 210, 220, and 230, a push sensor network 310, a pull sensor network 320, a hybrid sensor network 330, and a user interface 400.

The heterogeneous sensor network query processor 100 combines the sensor networks 310, 320, and 330 having different data dissemination approaches through the gateways 210, 220, and 230, and simultaneously processes a plurality of push queries and pull queries to optimize them.

The sensor network 310 uses the push data dissemination approach that the respective sensor nodes SN11 to SN14 transmit the data to the gateway 210 directly or through another sensor node SN11 to SN14 as soon as the respective sensor nodes SN11 to SN14 receive the data. The sensor network 320 uses the pull approach, that is, an on-demand data dissemination approach that the respective sensor nodes SN21 to SN29 receive a data acquisition query directly from the gateway 220 or through another sensor node, and transmit the data acquisition query to the gateway 220 directly or through another sensor node SN21 to SN29. The data dissemination approach in the sensor network 330 is a combined format of the push approach and the pull approach, the data are collected according to the data acquisition queries according to the pull approach when using the middle nodes SN31 and SN32, and the data are transmitted to the middle nodes SN31 and SN32 according to the push approach without data acquisition queries when using other nodes SN33 to SN35.

The user interface 400 receives queries requested by the user irrespective of the characteristics of the sensor network 310, 320, and 330. In this instance, the queries to be input by the user includes a push query, a pull query, an event query, a continuous query, a condition query, an in-network query, and a collection query. Here, the event query is a query that is performed when a predetermined event is satisfied, and for example, it is expressed as “Find the identifier (ID) and the temperature when a signal is generated”. The condition query is a query including a condition operator, and for example, it is expressed as “Find the identifier (ID) and the temperature of each node when the temperature is greater than 10”. The in-network query is a query including a totaling operator such as the average (AVG), minimum (MIN), maximum (MAX), and counts (COUNT), and it is expressed as “Find the average of the temperatures of the identifiers”.

Referring to FIG. 1 and FIG. 2, since the push query Q11 for transmitting the data on the sensor network 310 is transmitted as soon as the data are acquired from the sensor node SN11 to SN14, it is a query of “Find the identifier and the temperature of each node for 10 seconds” for generating a buffer for the continuous query without a data acquisition query and performing a continuous query. In this instance, the push approach query Q11 is also called a continuous query.

Referring to FIG. 1 and FIG. 3, the pull query Q12 for transmitting the data on the sensor network 320 is a data acquisition query, and is transmitted from the heterogeneous sensor network query processor 100 to the sensor node SN21 to SN29. The pull query Q12 is a query for “Find the identifiers and the temperatures of the respective nodes SN21 to SN29 at regular intervals of 10 seconds” and is called a collection query.

Accordingly, the heterogeneous sensor network query processor 100 of the heterogeneous wireless network according to an exemplary embodiment of the present invention can process both the pull query and the push query.

The method for the heterogeneous sensor network query processor 100 of the heterogeneous wireless network according to an exemplary embodiment of the present invention to process the data dissemination approach has been described with reference to FIG. 1 to FIG. 3, and the heterogeneous sensor network query processor 100 may process queries of sensor networks having a different query processing capability to each other.

As shown in FIG. 4, the heterogeneous wireless network includes a heterogeneous sensor network query processor 100, a plurality of gateways 240, 250, and 260, sensor networks 340, 350, and 360 having different query processing capabilities, and a user interface 400.

The sensor networks 340, 350, and 360 having different query processing capabilities according to the exemplary embodiment of the present invention has been described by using the sensor network for transmitting data through the pull approach, but the present invention is not restricted to this, and different query processing capabilities on the sensor network by using the sensor network for processing the data according to the push approach and the sensor network for transmitting the data according to the hybrid approach can be used.

The sensor network 340 supports the condition query Q3 and the event query Q4 in the respective sensor nodes SN41 to SN44, and the sensor network 350 supports the in-network query Q2 in the respective sensor nodes SN51 to SN59. The sensor network 360 supports the continuous query Q1 in the respective sensor nodes SN61 to SN65. Accordingly, various types of queries may or may not be supported by the sensor networks 340, 350, and 360. In the case of the queries supported by the sensor networks 340, 350, and 360, the corresponding query is directly transmitted to the sensor network to acquire result data for the query. However, in the case of the queries that are unsupportable by the sensor networks, a process for reading data from all the sensor nodes and performing the unsupported queries are to be additionally performed.

For example, since the sensor network 340 supports the condition query Q3 and the event query Q4 and the in-network query Q2 does not support them, a process for reading the data from the sensor nodes SN41 to SN44 and performing the in-network query Q2 is to be further performed in order for the support sensor network 340 to support the in-network query Q2.

To combinatively manage the heterogeneous sensor network having different query processing capabilities and data dissemination approaches, a processor for combining and converting the query of the heterogeneous sensor network is required, which will be described with reference to FIG. 5 to FIG. 7.

FIG. 5 is a block diagram of a heterogeneous sensor network query processor 100 according to an exemplary embodiment of the present invention.

As shown in FIG. 5, the heterogeneous sensor network query processor 100 includes a query queue 110, a query evaluator 120, a sensor network metadata manager 130, a query combining and converting 140, a data combiner 150, and a query command manager 160.

The heterogeneous sensor network query processor 100 stores the queries that are input by a user interface in the query queue 110, and evaluates each of the stored queries using the query evaluator 120. In this instance, the query evaluator 120 applies data dissemination approach and query processing capability of each sensor network to query evaluation by referring to the sensor network metadata manager 130. The sensor network metadata manager 130 has characteristic information including data dissemination approach and query processing capability of each sensor network.

The query combining and converting unit 140 combines or converts the queries so as to minimize the cost of the entire network system through the query evaluation result transmitted from the query evaluator 120. That is, the query combining and converting unit 140 mutually combines and converts the push query and the pull query to optimize the queries. The query combining and converting unit 140 according to the embodiment uses a policy for minimizing the number of pull queries so as to minimize the cost of the entire network system and a policy for converting the query so as to process the queries in the level of the sensor network.

The query command manager 160 manages the currently performed pull-based queries, and transmits the combined and converted query commands to the gateways. In this instance, the data combiner 150 manages the data based on the query command result or the data transmitted by the push approach, and transmits the corresponding result to the user interface.

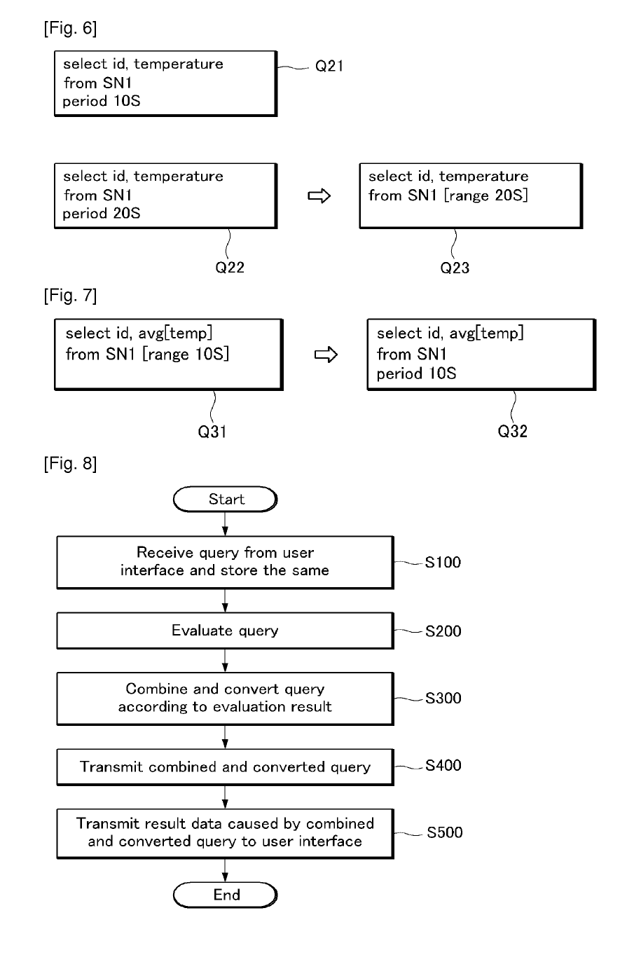

Referring to FIG. 6 and FIG. 7, examples will be described for optimizing the query in the heterogeneous sensor network query processor shown in FIG. 5.

FIG. 6 is an example for minimizing the number of pull approach queries according to an exemplary embodiment of the present invention, and FIG. 7 is an example of a query optimization policy using query processing capability of a sensor network according to an exemplary embodiment of the present invention.

As shown in FIG. 6, when performing the repeated pull query Q22 from among the pull query Q21 and the pull query Q22 that are simultaneously performed so as to perform the policy for minimizing the number of pull queries, the heterogeneous sensor network query processor 100 does not access the sensor network, but converts the pull query Q22 into the push query Q23 and processes the pull query Q22 so as to use the sensor data following the pull query Q21. That is, the cost of the entire system is reduced by reducing the number of pull queries.

For example, it will be assumed that the pull query Q21 of “Find the identifier and temperature of each node at regular intervals of 10 seconds (select id, temperature from SN1 period 10 s)” and the pull query Q22 of “Find the identifier and temperature of each node at regular intervals of 20 seconds (select id, temperature from SN1 period 20 s)” are given. In this instance, sensor data for the identifier and temperature of each node during 20 seconds can be acquired by using the sensor data for the identifier and temperature of each node during 10 seconds according to the pull query Q21. Therefore, the heterogeneous sensor network query processor 100 converts the pull query Q22 into the push query Q23 of “Find the identifier and the temperature of each node during 20 seconds (select id, temperature from SN1 [range 20 s])” to thus process the pull query Q22 for finding the identifier and the temperature of each node during 20 seconds without accessing the sensor network. That is, the heterogeneous sensor network query processor 100 converts the repeated pull query Q22 into the push query Q23 from among the pull query Q21 and the pull query Q22, and then processes the push query Q23.

As shown in FIG. 7, the query optimization policy using the query processing capability of the sensor network converts the push query Q31 into the pull query Q32 to process the corresponding query in the level of the sensor network when the corresponding sensor network supports the in-network query, the event query, and the condition query from the push query Q31.

For example, it is assumed that a push query Q31 of “Find the identifier and the average of each node during 10 seconds (select id, avg[temp] from SN1[range 10 s])” is given. In this instance, for example, when the corresponding sensor network supports collection query capability, the heterogeneous sensor network query processor 100 converts the push query Q31 into the collection query Q32 of “Find the identifier and the average of each node during 10 seconds (select id, avg[temp] from SN1 period 10 s)” and processes the query by using the query processing capability of the in-network query of the corresponding sensor network.

FIG. 8 is a flowchart of an efficiency query processing method performed by a heterogeneous sensor network query processor according to an exemplary embodiment of the present invention.

The heterogeneous sensor network query processor 100 receives the queries requested by the user irrespective of the characteristic of the sensor network, and stores the same in the query queue 110 (S100). The query evaluator 120 evaluates each of the input queries (S200) to transmit the evaluated queries to the query combining and converting unit 140.

The query combining and converting unit 140 combines and converts the queries according to the evaluation result so as to minimize the cost of the entire network system (S300).

The query command manager 160 manages the currently performed pull based queries and transmits the combined and converted queries to the gateways (S400). The data combiner 150 manages the data based on the combined and converted query result or the data transmitted by the push approach, and transmits the corresponding result to the user interface (S500).

The above-described embodiments can be realized through a program for realizing functions corresponding to the configuration of the embodiments or a recording medium for recording the program in addition to through the above-described device and/or method, which is easily realized by a person skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. An apparatus for processing a plurality of queries from a plurality of heterogeneous sensor networks, comprising:
a query queue receiving a plurality of queries from a user interface and storing the queries;
a query combining and converting unit combining or converting the queries according to the heterogeneous sensor networks;
a query command manager transmitting the combined or converted query to a corresponding sensor network of the heterogeneous sensor networks; and
a data combiner transmitting a result based on data received from the heterogeneous sensor networks to the user interface.

2. The apparatus of claim 1, further comprising:
a sensor network metadata manager having information on the heterogeneous sensor networks; and
a query evaluator evaluating the queries by using the information on the heterogeneous sensor networks,
wherein the query combining and converting unit combines or converts the queries according to a query evaluation result by the query evaluator.

3. The apparatus of claim 1, wherein the plurality of heterogeneous sensor networks comprise:
a push sensor network having a first sensor node, the first sensor transmitting data to the apparatus as soon as acquiring; and
a pull sensor network having a second sensor node, the second sensor node collecting data to the apparatus according to a data acquisition query for acquiring the data from the apparatus and transmitting the collected data to the apparatus.

4. The apparatus of claim 3, wherein the heterogeneous sensor networks further comprise a hybrid sensor network using the push approach and the pull approach.

5. The apparatus of claim 1, wherein the query combining and converting unit converts the repeated query from among a plurality of pull queries that are performed at the same time for the heterogeneous sensor networks into a push query.

6. The apparatus of claim 1, wherein the query combining and converting unit converts at least part of a plurality of push queries into a query corresponding to query processing capability supported by the corresponding sensor network.

7. The apparatus of claim 6, wherein the query processing capability comprises at least one of an event query, a continuous query, a condition query, an in-network query, and a collection query.

8. A method for processing a plurality of queries from a plurality of heterogeneous sensor networks, comprising:
receiving and storing the queries that are performed at the same time for the heterogeneous sensor networks;
combining or converting the queries by using information on the heterogeneous sensor networks;
transmitting the combined or converted queries to a corresponding sensor network from among the heterogeneous sensor networks; and
receiving the data following the combined or converted queries from the heterogeneous sensor networks.

9. The method of claim 8, wherein information on the heterogeneous sensor networks comprises at least one of query approaches supported by the sensor networks and query processing capability supported by the sensor networks.

10. The method of claim 9, wherein the query approach comprises at least one of a push approach, a pull approach, and a hybrid approach.

11. The method of claim 9, wherein the query processing capability comprises at least one of an event query, a continuous query, a condition query, an in-network query, and a collection query.

12. The method of claim 8, wherein the combination or conversion of queries further comprises converting a repeated query from among a plurality of pull approach queries that are performed at the same time for the heterogeneous sensor networks into a push query.

13. The method of claim 8, wherein the combination or conversion of queries further comprises converting at least part of a plurality of push approach queries into a query corresponding to query processing capability supported by the corresponding sensor network.
